(19) United States
(12) Patent Application Publication
(10) Pub. No.: US 2024/0242629 A1
(43) Pub. Date: Jul. 18, 2024

(54) Vessel Anastomosis Task Trainer for the Novice Student

(71) Applicants: Sarah Ann Seymour, South Dartmouth, MA (US); Jphn Robert Seymour, South Dartmouth, MA (US)

(72) Inventors: Sarah Ann Seymour, South Dartmouth, MA (US); Jphn Robert Seymour, South Dartmouth, MA (US)

(21) Appl. No.: 18/154,686

(22) Filed: Jan. 13, 2023

(51) Int. Cl. G09B 23/30

(52) U.S. Cl. CPC G09B 23/30

(57) ABSTRACT

A surgical task trainer is provided to train the novice student in the fundamental skills of vessel anastomosis without the aid of a surgical assistant. The trainer includes (1) a stable base with a non-slip stabilization grip at each end to secure the target artificial blood vessel. Threaded holes within the stable base receive and stabilize (2) a damped adjustable support arm comprising a visco-elastic damping element and a non-slip vessel stabilization grip to stabilize the non-target artificial blood vessel, (3) an adjustable suture thread tensioning assembly to apply adjustable tension to the suture thread, and (4) an adjustable arteriotomy stabilization apparatus to open and stabilize the incision in the target artificial blood vessel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE ELECTRONIC FILING SYSTEM

Not Applicable

### STATEMENT REGARDING PRIOR DISCLOSURES BY THE INVENTOR OR A JOINT INVENTOR

Not Applicable

### BACKGROUND OF THE INVENTION

### (1) Field of the Invention

The present invention relates generally to an apparatus for the unassisted training of a novice student in the fundamental skills required to complete a vessel anastomosis

### (2) Background Art

In the field of vascular surgery, it is well known that surgical trainees must practice suturing one vessel to another, known as a vessel anastomosis, to become highly competent within their craft. Vessel anastomosis task trainers allow surgical trainees to practice and refine their technique outside of the operating room in a low-stakes environment. However, the existing task trainers are not intended or designed for the novice student attempting to learn the fundamental skills required to complete a vessel anastomosis without the aid of an assistant. For instance, certain medical suppliers (i.e. Gore) provide basic box trainers intended to showcase their graft and suturing products. However, for a student to practice the proper anastomosis technique, these trainers require a surgical assistant holding (1) the non-target blood vessel in the desired orientation and (2) the suture thread at the desired tension and orientation. This design presents a major barrier to students who lack access to surgical assistants and/or wish to practice their technique alone. Additionally, while some vessel anastomosis trainers (i.e. Chamberlain Group) offer an assistive apparatus to hold the non-target vessel in the appropriate orientation, these apparatuses do not allow for versatile adaptability, nor do they include a mechanism that reduces vibrations within the non-target vessel to provide stability. These designs also fail to include an apparatus that applies a desired tension to the suture thread while suturing. Finally, additional vessel anastomosis trainers exist with steep, awkward angles and/or a recessed surgical field that make it excessively difficult for the novice student to master the fundamental skills. Taken together, these design insufficiencies create obstacles for the novice student attempting to learn how to perform the vessel anastomosis unassisted. Therefore, the medical profession would benefit from a training device that eliminates these barriers.

### BRIEF SUMMARY OF THE INVENTION

This invention will allow a novice student to learn and master the basic, fundamental skills required for a vessel anastomosis at a convenient time and setting, thereby enhancing their learning experience in the operating room. The present invention was developed according to specific requirements discussed below. One requirement is that the task trainer be easy to use by the novice student without the aid of an assistant. The second requirement is that the device be adaptable and adjustable, yet stable, to perform a vessel anastomosis at different orientations. The present invention provides an assembly that meets all the above requirements. In an exemplary embodiment of the invention, the vessel anastomosis task trainer is comprised of four components: (1) a damped adjustable support arm; (2) an adjustable suture thread tensioning assembly; (3) an adjustable arteriotomy stabilization apparatus; and (4) a stable base. More specifically, the vessel anastomosis training device of this invention contains a stable base with a non-slip stabilization grip at each end to secure the target vessel in a horizontal, fixed position. Included within the stable base are threaded holes to fasten and secure the following three assistive mechanisms in different positions. (1) A damped adjustable support arm holds the non-target artificial blood vessel in a variety of stable orientations necessary to perform a vessel anastomosis. This damped adjustable support arm is comprised of a visco-elastic damping element that reduces vibrations of the non-target artificial blood vessel, providing greater stability while suturing. A threaded rod is used to fasten the damped adjustable support arm to the stable base in different locations. (2) An adjustable suture thread tensioning assembly applies adjustable tension to suture thread of different gauges. This allows the student to secure suture thread at a desired orientation under a desired tension, which is released when the thread is pulled gently with one hand. This assembly is comprised of two annular, beveled disks placed under adjustable spring compression, through which a threaded rod runs to fasten the assembly to the stable base in different locations. (3) An adjustable arteriotomy stabilization apparatus affixes suture thread to the stable base in different positions at the periphery of the surgical field to enable access to, and stabilization of, the arteriotomy. This apparatus is comprised of an annular disk through which a threaded rod runs to fasten the apparatus to the stable base in different locations.

### BRIEF DESCRIPTION OF THE SEVERAL VIEWS OF THE DRAWINGS

FIG. 1 is an isometric top view of the anastomosis task trainer assembly in accordance with this invention.

FIG. 2 is a cross section view of the damped adjustable support arm, illustrating the structural and visco-elastic components of the arm.

FIG. 3 is an isometric bottom view of the anastomosis task trainer assembly, illustrating the non-slip support feet underneath the stable base.

### DETAILED DESCRIPTION OF THE INVENTION

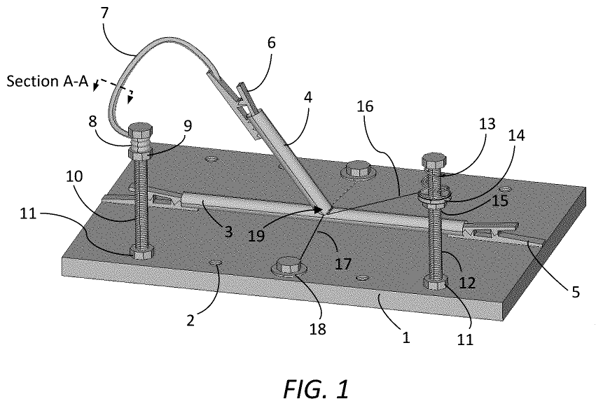

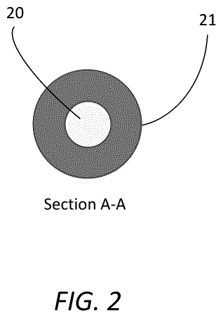

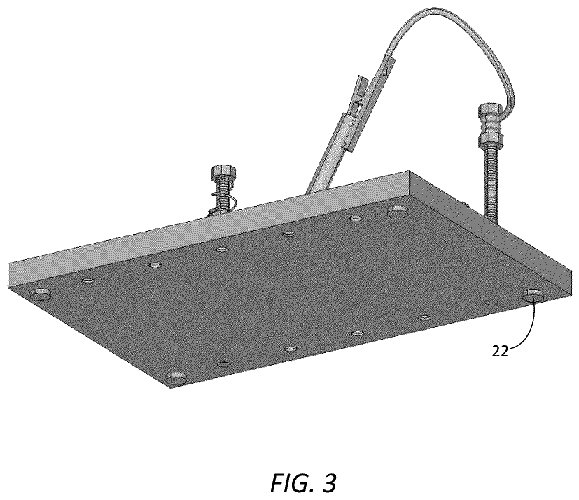

Referring to FIG. 1, the anastomosis task trainer consists of a stable base 1 that supports various subcomponents of the anastomosis task trainer assembly. Non-slip target vessel stabilization grips 5 are attached to the stable base 1 in a manner that prevents both translation and rotation of the non-slip target vessel stabilization grips 5. A target artificial blood vessel 3 is horizontally attached to, and fully supported by, the stable base 1 via the non-slip target vessel stabilization grips 5. The target artificial blood vessel 3 is held by the non-slip stabilization grips 5 in slight tension to reduce lateral and torsional motion of the target artificial blood vessel during anastomosis training. A non-target artificial blood vessel 4 is held in a predetermined and desirable position by a non-slip vessel stabilization grip 6, in order to perform the vessel anastomosis. The non-slip vessel stabilization grip 6 is firmly attached to and supported by a damped adjustable support arm 7. Referring to FIG. 2, the damped adjustable support arm 7 is comprised of an inner structural stiffening core 20, with an exterior layer of visco-elastic damping material 21. The visco-elastic damping material 21 is shrunk on and bound to the inner structural core 20 with a thin adhesive. The thin adhesive provides a tight coupling between the structural core 20 and the visco-elastic damping material 21 to transfer vibratory strains within the structural core 20 to the visco-elastic damping material 21, which provides vibration damping and attenuation. This design attribute mechanism vastly reduces undesirable vibration of the non-target artificial blood vessel 4, providing the user with a structurally stable artificial blood vessel and an increased ability to focus on vessel anastomosis training. Referring to FIG. 1, the end of the damped adjustable support arm 7 at the opposing end of the grip 6 is wound several times 8 around a threaded rod or bolt 10, thereby securing the arm 7 to the threaded rod or bolt 10 in translation but allowing rotation about the axis of the threaded rod or bolt 10. It is significant that the wound portion of the adjustable support arm 8 contains a visco-elastic exterior as this section of the arm 8 experiences the greatest mechanical strain and therefore greatest opportunity for damping and subsequent vibration attenuation of the non-target vessel. Once the desired rotation and orientation of the adjustable support arm 7 is obtained to properly position the non-target artificial blood vessel 4, the adjustable support arm tightening nut 9 is tightened to maintain the desired arm 7 rotation and orientation. The threaded rod or bolt 10 can then secure the adjustable support arm 7 onto the stable base 1 via the threaded holes 2. The tightening nut 11 is tightened down onto the stable base 1 to prevent undesirable rotation of the adjustable support arm 7. The stable base 1 contains a number of available threaded mounting holes 2 around the perimeter of the base, allowing for various locations of threaded rods 10, 12, and 18. The flexibility of the adjustable support arm 7 combined with adjustable rotation 8 and various threaded hole locations 2, provide a fully articulating method of stabilizing the non-target artificial blood vessel 4 to afford many options on vessel length, orientation, and position to maximize vessel anastomosis training opportunities without the aid of an assistant. A significant design feature of the anastomosis task trainer is an adjustable suture thread tensioning assembly, which further facilitates the ability of the student to perform a vessel anastomosis without the aid of an assistant. The following suture thread 16 extending from the vessel anastomosis junction 19 is placed between two vertically stacked annular beveled clamping disks 14. The clamping disks 14 are supported from below by a tightening nut 15 and compressed from above by a coil spring 13. A threaded bolt or rod 12 passes through the tightening nut 15, clamping disks 14, and spring 13, allowing concentric positioning of the tightening nut 15, clamping disks 14, and spring 13 along the axis of the rod 12. The magnitude of compressive force between the clamping disks 14 is adjustable by tightening or loosening the tightening nut 15. With the following suture thread 16 passing between the clamping disks 14, the compressive force between the clamping disks 14 is directly transferred to the following suture thread 16, allowing the following suture thread 16 to be held in tension. The suture thread tension is therefore fully adjustable by tightening or loosening the tightening nut 15. This ability to fine tune thread tension allows for unassisted vessel anastomosis training for a variety of potential scenarios such as different suture thickness or material, artificial vessel thickness or material, or suturing techniques. The anastomosis task trainer comprises an adjustable arteriotomy stabilization apparatus that tensions suture thread at various orientations in the periphery of the surgical field to enable access to, and stabilization of, the arteriotomy. A threaded rod or bolt 18 is threaded into one of the threaded holes 2 in the stable base 1. A secondary and independent suture thread 17 is affixed to the target artificial blood vessel 3 near the anastomosis intersection 19, then led to the threaded bolt or rod 18. The suture thread 17 is then pulled to a desired tension, and the threaded rod or bolt 18 is tightened. This procedure is repeated on the opposite side of the base and anastomosis intersection 19 to provide a stable opening of the target artificial blood vessel 3 as well as lateral stabilization of the surgical field. Referring to FIG. 3, the stable base 1 is outfitted with non-slip support feet 22 in each of the four corners of the base 1, which prevent sliding of the anastomosis task trainer on a desk or work surface.

1. A vessel anastomosis task trainer comprising:
a. A damped adjustable support arm
b. A stable base
c. An adjustable suture thread tensioning assembly
d. An adjustable arteriotomy stabilization apparatus.

2. A vessel anastomosis task trainer as set forth in claim 1, wherein said damped adjustable support arm further comprises a non-slip stabilization grip at one end to hold the non-target artificial blood vessel in the desired orientation.

3. A vessel anastomosis task trainer as set forth in claim 1, wherein said damped adjustable support arm further comprises an inner structural core that is flexible and holds its shape after adjusted.

4. A vessel anastomosis task trainer as set forth in claim 1, wherein said damped adjustable support arm further comprises an exterior layer of visco-elastic damping material to reduce vibrations and improve stability of the non-target artificial blood vessel.

5. A vessel anastomosis task trainer as set forth in claim 1, wherein said damped adjustable support arm further comprises a threaded rod that can be fastened to said stable base in different locations.

6. A vessel anastomosis task trainer as set forth in claim 1, wherein said stable base further comprises threaded holes to fasten down said damped adjustable support arm, said adjustable suture thread tensioning assembly, and said adjustable arteriotomy stabilization apparatus in different locations.

7. A vessel anastomosis task trainer as set forth in claim 1, wherein said stable base further comprises two non-slip stabilization grips on opposite sides of said base to secure the target vessel in a fixed, horizontal position.

8. A vessel anastomosis task trainer as set forth in claim 1, wherein said adjustable suture thread tensioning assembly further comprises an annular spring, two annular beveled disks, and an adjustable nut assembled in series to provide adjustable spring compression to hold suture thread at the desired tension.

9. A vessel anastomosis task trainer set forth in claim 1, wherein said adjustable suture thread tensioning assembly further comprises a threaded rod that can be fastened to said stable base in different locations.

10. A vessel anastomosis task trainer as set forth in claim 1, wherein said adjustable arteriotomy stabilization apparatus further comprises a threaded rod through which runs an annular disk that can be fastened to said stable base in different locations to secure suture thread in different orientations, opening and stabilizing the arteriotomy.
